(19) United States
(12) Patent Application Publication
(10) Pub. No.: US 2012/0007836 A1
(43) Pub. Date: Jan. 12, 2012

(54) TOUCH SCREEN UNLOCKING DEVICE AND METHOD

(75) Inventors: WEI WU, Shenzhen City (CN); XIN YANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/848,200

(22) Filed: Aug. 1, 2010

(30) Foreign Application Priority Data
Jul. 8, 2010 (CN) 201010221676.5

(51) Int. Cl. G06F 3/043; G06F 3/041

(52) U.S. Cl. 345/177; 345/173

(57) ABSTRACT

A touch screen unlocking device for an electronic device equipped with a touch screen. The touch screen unlocking device includes a sensor, a processing unit, a screen control unit, a measuring unit, and a timing unit. The sensor is configured for detecting a signals generated by a tap on the touch screen. The screen control unit is configured to transmit a tap signal to the processing unit when detecting the touch screen is tapped. The measuring unit is configured to measure the frequency of the signals, and transmit a frequency-affirming signal to the processing unit when the frequency drops within a predetermined frequency range. The timing unit is configured to transmit a time-affirming signal to the processing unit when the interval between two consecutive taps drops within a predetermined time span.

### BACKGROUND

1. Technical Field

The present disclosure relates to touch screen unlocking devices and methods, and particularly, to a touch screen unlocking device and a touch screen unlocking method for a portable electronic device equipped with a touch screen.

2. Description of Related Art

Many portable electronic devices are equipped with a touch screen. Conventionally, to access a locked portable electronic device equipped with a touch screen, the touch screen displays a special icon. When users want to unlock the electronic device, they have to press the special icon and drag it along a given track, which is inconvenient.

Therefore, it is desirable to provide a new touch screen unlocking device which can overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure.

FIG. 1 is a functional block diagram of a touch screen unlocking device, according to an exemplary embodiment.

FIG. 2 is a flow chart of a present touch unlocking method, according to an exemplary embodiment.

### DETAILED DESCRIPTION

Embodiments of the present disclosure will now be described in detail with reference to the drawings.

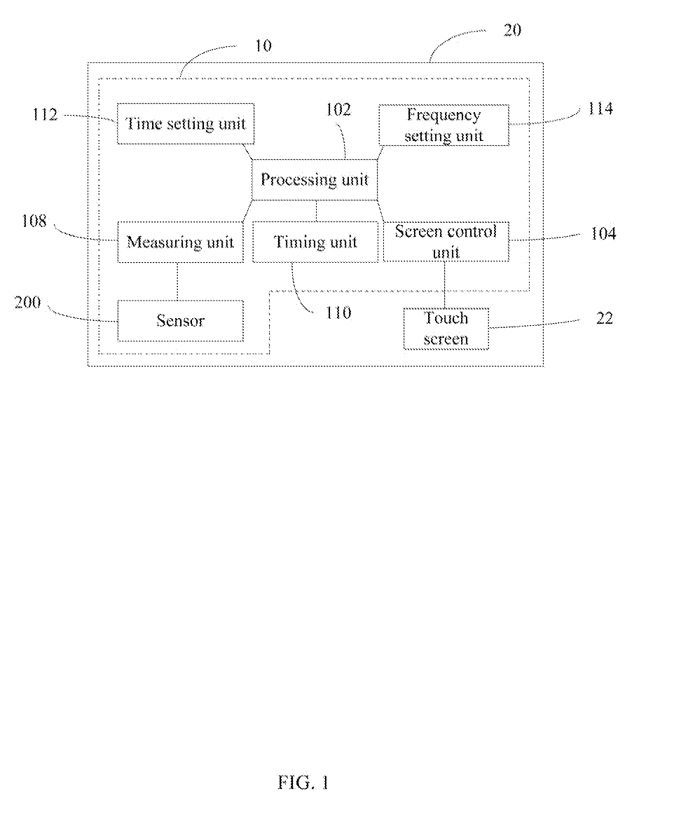

Referring to FIG. 1, a portable electronic device 20, according to an exemplary embodiment, comprises a touch screen 22. To access the portable electronic device 20, users usually tap the touch screen 22 with a stylus (not shown) or their finger. The users' taps on the touch screen 22 generate some recognizable/identifiable signals, such as vibration and sound. Herein tap refers to light striking motions upon the surface of the touch screen 22 of the electronic device 20.

A touch screen unlocking device 10, according to an exemplary embodiment, is positioned in the portable electronic device 20. The touch screen unlocking device 10 includes a processing unit 102, a screen control unit 104, a measuring unit 108, a timing unit 110, and a sensor 200. In the present embodiment, the sensor 200 may be a vibration sensor attached to the center of the back of the touch screen 22 for detecting vibration, or an acoustic sensor attached to one corner of the back of the touch screen 22 for detecting sound.

The screen control unit 104 is connected to the processing unit 102 and the touch screen 22 of the portable electronic device 20. The screen control unit 104 is used to detect whether the touch screen 22 is tapped, and to transmit a tap signal to the processing unit 102 when detecting that the touch screen 22 is tapped. The screen control unit 104 is also configured to unlock the touch screen 22 when receiving an unlocking signal from the processing unit 102 (see below).

The measuring unit 108 is connected to the processing unit 102 and the sensor 200. The measuring unit 108 analyses the frequency of the signals generated by a tap on the touch screen 22 and detected by the sensor 200. The measuring unit 108 is also configured to transmit a frequency-affirming signal to the processing unit 102 when determining that the frequency of the signals drops within a predetermined frequency range.

The frequency of the signals generated by a tap may vary, depending on different objects which come in contact with the touch screen 22. Since users usually use the same object, such as their finger, over and over to tap the touch screen 22, the frequency of the signals generated by the tap of a finger remains relatively constant. As such, it can prevent the touch screen 22 from being unlocked by other objects by analyzing whether the frequency of the signals generated by the objects drops within the predetermined frequency range.

In the present embodiment, users tap the touch screen 22 with a finger. The predetermined frequency range ranges between about 50 HZ to about 550 HZ, which corresponds to the frequency range of a finger. Therefore, the touch screen 22 can not be unlocked by contacts of other objects, such as a pen or whichever generates signals that the frequency thereof is not in the predetermined frequency range when they coming into contact with the touch screen 22. Users have to continuously tap the touch screen 22 twice to unlock the touch screen 22, which can prevent the touch screen 22 from being unlocked when users inadvertently tap the touch screen 22.

The timing unit 110 is connected to the processing unit 102. The timing unit 110 is used to determine whether the time interval between two consecutive taps drops within a predetermined time span, and transmit a time-affirming signal to the processing unit 102 when determine that the time interval between two consecutive taps drops within the predetermined time span. The predetermined time span may range from about 0.2 second to about 1 second. In the present embodiment, the predetermined time span is 0.5 second. Since the interval between the two consecutive taps is limited to a predetermined time span, the touch screen 22 would not be unlocked by a second tap which occurs after the predetermined time span.

When a first tap signal is generated by the screen control unit 104, a first frequency-affirming signal is generated by the measuring unit 108, then a second tap signal is generated by the screen control unit 104, a time-affirming signal is generated by the timing unit 110 and a second frequency-affirming signal is generated by the measuring unit 108, then the processing unit 102 transmits an unlocking signal to the screen control unit 104 to unlock the touch screen 22.

In operation, when the users' finger taps the touch screen 22 twice, the screen control unit 104 detects the tap and then transmits a first tap signal to the processing unit 102. The processing unit 102 immediately transmits a first trigger signal to the timing unit 110. The first trigger signal triggers the timing unit 110 to start timing. Meanwhile, the processing unit 102 controls the measuring unit 108 to measure the frequency of the signals generated by the first tap. If the measuring unit 108 determines that the frequency drops within the predetermined frequency range, it then transmits a first frequency-affirming signal to the processing unit 102.

At the second tap, the screen control unit 104 transmits a second tap signal to the processing unit 102. The processing unit 102 then transmits a second trigger signal to the timing unit 110 to stop timing. If the interval between the two taps falls within the predetermined time span, the timing unit 110 transmits a time-affirming signal to the processing unit 102. Then the processing unit 102 controls the measuring unit 108 to measure the frequency of the signals generated by the second tap. The measuring unit 108 transmits a second frequency-affirming signal to the processing unit 102 after determining that the frequency of the signals generated by the second tap falls within the predetermined frequency range. At this moment, the processing unit 102 transmits an unlock signal to the screen control unit 104. The screen control unit 104 then unlocks the touch screen 22 when it receives the unlock signal.

In alternative embodiments, the processing unit 102 includes a time setting unit 112 and a frequency setting unit 114 both connected to the processing unit 102. The time setting unit 112 provides a way for users to preset the predetermined time span as they desire, this enable users to change the interval between the two consecutive taps to configure different tapping habits of different users. The frequency setting unit 114 allows users to set the predetermined frequency range of the signals to match different objects used by different users.

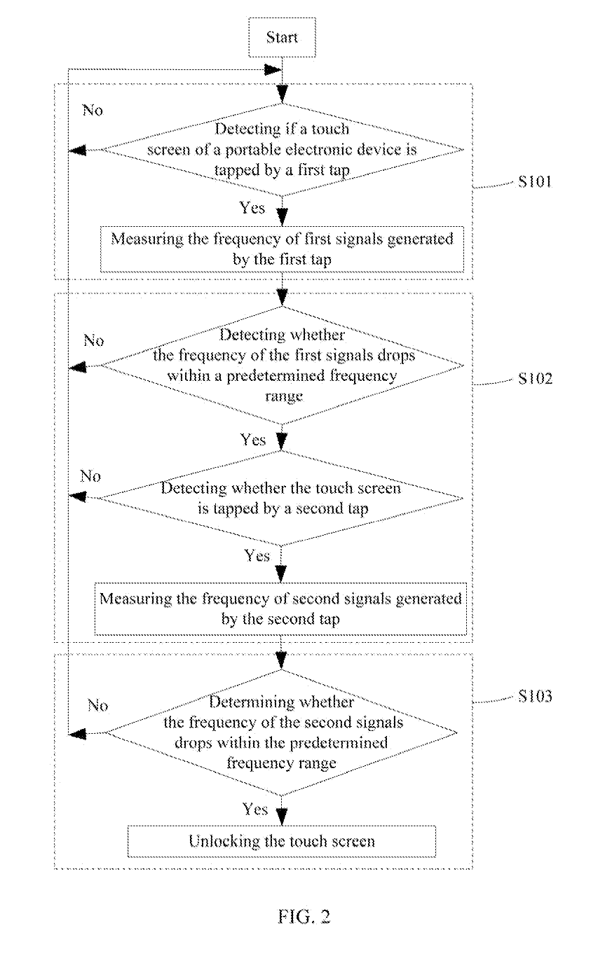

Referring to FIG. 2, a screen unlocking method, according to one embodiment, includes the following steps.

S101: Detecting if a touch screen of a portable electronic device is tapped by a first tap; if so, measuring the frequency of first signals generated by the first tap, otherwise, the portable electronic device 20 remains locked.

S102: Determining whether the frequency of the first signals drops within a predetermined frequency range; if not, returning to step S101, otherwise, detecting whether the touch screen is tapped by a second tap; if not, returning to step S101, otherwise, measuring the frequency of second signals generated by the second tap.

S103: Determining whether the frequency of the second signals drops within the predetermined frequency range; if not, returning to step S101, otherwise, unlocking the touch screen.

It will be understood that the above particular embodiments is shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A touch screen unlocking device for an electronic device having a touch screen, the touch screen unlocking device comprising:
a sensor configured for detecting signals generated by a tap on the touch screen;
a processing unit;
a screen control unit connected to the processing unit, and configured to transmit a tap signal to the processing unit when detecting that the touch screen is tapped, and unlock the touch screen when receiving an unlocking signal from the processing unit;
a measuring unit connected to the processing unit and the sensor, the measuring unit being configured to measure the frequency of the signals detected by the sensor when the touch screen is tapped, and transmit a frequency-affirming signal to the processing unit when determining that the frequency of the signals drops within a predetermined frequency range; and
a timing unit connected to the processing unit, and configured to transmit a time-affirming signal to the processing unit when determining that the interval between the two consecutive taps on the touch screen drops within a predetermined time span.

2. The touch screen unlocking device of claim 1, wherein the predetermined frequency range of the signals is between about 50 HZ and about 550 HZ.

3. The touch screen unlocking device of claim 1, wherein the predetermined time span ranges from about 0.2 second to about 1 second.

4. The touch screen unlocking device of claim 3, wherein the predetermined time span is 0.5 seconds.

5. The touch screen unlocking device of claim 1, wherein when a first tap signal is caused by a first tap and transmitted to the processing unit by the screen control unit, a first frequency-affirming signal is transmitted to the processing unit by the measuring unit; when a second tap signal is caused by a second tap and transmitted to the processing unit by the screen control unit, a time-affirming signal is generated and transmitted to the processing unit by the timing unit, and a second frequency-affirming signal is generated and transmitted to the processing unit by the measuring unit, then the processing unit transmits an unlocking signal to the screen control unit to unlock the touch screen.

6. The touch screen unlocking device of claim 5, wherein when the processing unit receives the first tap signal and the second tap signal from the screen control unit respectively, it controls the measuring unit to measure the frequency of first signals generated by the first tap and the frequency of second signals generated by the second tap correspondingly; when the measuring unit determines that the frequencies of the first signals and the second signals drop within the predetermined frequency range, it transmits the first frequency-affirming signal and the second frequency-affirming signal to the processing unit correspondingly.

7. The touch screen unlocking device of claim 5, wherein when the processing unit receives the first tap signal from the screen control unit, it transmits a first trigger signal to the timing unit to trigger the timing unit to start timing; when the processing unit receives the second tap signal from the screen control unit, it transmits a second trigger signal to the timing unit to trigger the timing unit to stop timing; the timing unit sends the time-affirming signal to the processing unit after determining that the interval between the first and second taps drops within the predetermined time span.

8. The touch screen unlocking device of claim 1, further comprising a time setting unit connected to the processing unit, and configured to provide a way for users to set the predetermined time span.

9. The touch screen unlocking device of claim 1, further comprising a frequency setting unit connected to the processing unit, and configured to provide a way for users to set the predetermined frequency range of the recognizable signal.

10. The touch screen unlocking device of claim 1, wherein the sensor is a vibration sensor attached to the central of the back of the touch screen.

11. The touch screen unlocking device of claim 1, wherein the sensor is an acoustic sensor attached to one corner of the back of the touch screen.

12. A screen unlocking method for an electronic device having a touch screen, the method comprising:
detecting if the touch screen is tapped by a first tap; if so, measuring the frequency of first signals generated by the first tap, otherwise, the electronic device remains locked;
determining whether the frequency of the first signals drops within a predetermined frequency range; if not, returning to the first step, otherwise, detecting whether the touch screen is tapped by a second tap; if not, returning to the first step, otherwise, measuring the frequency of second signals generated by the second tap; and
determining whether the frequency of the second signals drops within the predetermined frequency range; if not, returning to the first step, otherwise, unlocking the touch screen.

13. The method of claim 12, wherein the first and second signals are detected by a vibration sensor.

14. The method of claim 12, wherein the first and second signals are detected by an acoustic sensor.

15. A screen unlocking method for an electronic device having a touch screen and a processing unit, the method comprising:
generating a first tap signal and transmitting the first tap signal to the processing unit if a first tap is applied on the touch screen;
generating a first frequency-affirming signal and transmitting the first frequency-affirming signal to the processing unit if the frequency of a signal generated by the first tap is measured to drop within a predetermined frequency range;
generating a second tap signal and transmitting the second tap signal to the processing unit if a second tap is applied on the touch screen;
generating a time-affirming signal and transmitting the time-affirming signal to the processing unit if the interval between the first and second taps is measured to drop within a predetermined time span;
generating a second frequency-affirming signal and transmitting the second frequency-affirming signal to the processing unit if the processing unit receives the time-affirming signal, and the frequency of a signal generated by the second tap is measured to drop within the predetermined frequency range; and
generating an unlocking signal by the processing unit to unlock the touch screen.
